(19) United States
(12) Patent Application Publication
(10) Pub. No.: US 2002/0074486 A1
(43) Pub. Date: Jun. 20, 2002

(54) Method and device for correcting shooting errors

(76) Inventors: Michael Gerber, Zurich (CH); Gabriel Schneider, Zurich (CH)

Correspondence Address: McCormick, Paulding & Huber, City Place II, 185 Asylum Street, Hartford, CT, 06103-3402, US

(21) Appl. No.: 09/977,417

(22) Filed: Oct. 15, 2001

(30) Foreign Application Priority Data
Dec. 19, 2000 (CH) 2000 2467/00

(51) Int. Cl. G01D 5/34

(52) U.S. Cl. 250/231.12

(57) ABSTRACT

Method and device for correcting shooting errors. Such shooting errors are to be corrected that are occasioned by a movement of a barrel (12) of a gun (10) out of its nominal position in consequence of a movement of a lower carriage (18) when a shot is being fired. By means of an angle meter element, an error angle is determined along which the lower carriage rotates about the vertical axis (Z). An error signal is obtained from the error angle. Said error signal is utilized to change the azimuth of the barrel of the weapon (12) in order to compensate an error of the azimuth and of the elevation occasioned by the rotation of the lower carriage (18) about the vertical axis (Z).

### CROSS REFERENCE TO RELATED APPLICATIONS

This application claims priority from and incorporates by reference the subject matter of Swiss Patent Application No. 2000 2467/00 filed Dec. 19, 2000.

### BACKGROUND OF THE INVENTION

The invention relates to a method and a device for correcting shooting errors caused by movement of a gun barrel from its normal position as a result of movements of the gun carriage upon firing of a shot.

The firing of shots through land-based guns produces high recoil forces which among others cause the lower gun carriage of the gun to move relative to its base area. Prior to firing a shot, the barrel of the weapon is aimed at a target or adopts a nominal directional position respectively. The movement the shot causes the lower carriage to describe entails that the barrel of the weapon is moved away from its nominal directional position. This is one reason for shooting errors to occur.

The movement the lower carriage describes may either be a displacement on the base area and/or a local sinking into the floor and, as a result thereof, across the base area. For the present, only the movement of the lower carriage on its base area will be considered.

A displacement on the base area occurs whenever the recoil forces exerted on the lower carriage are greater than the maximum frictional forces that can be generated and that are opposing such a displacement. The frictional forces in turn depend on the weight of the gun and on the coefficient of friction between the area supporting the gun and the base area. Obviously, the risk of such movements and, as a result thereof, the risk of shooting errors as well is greater with relatively light-weighted guns, relatively heavy projectiles, relatively high muzzle velocities and small coefficients of friction between the lower carriage and the base area.

Generally, the base area is not a geometrically accurate plane, neither is it necessarily an essentially horizontal area, it rather is in most cases an uneven ground as of meadows, woods or rocks. As a result, the coefficient of friction between base area and floor space of the gun or of the lower carriage respectively varies according to the location and furthermore depends on the respective nature of the base area. As a result thereof, the lower carriage not only moves backward in linear direction under the action of the recoil forces, or is respectively displaced in the opposite direction from the projection of the barrel of the weapon on the base area, it also rotates on the base area about the vertical axis. This movement accounts for the fact that the barrel of the weapon is turned off its nominal directional position by an error angle. Even if said error angle is small, the shooting errors resulting therefrom are considerable in consequence of the long shooting distances, at a shooting distance of 3000 m an error angle of 1° for instance brings about a shooting error, or a deviance, of approximately 50 m.

In artillery, when bombarding static or almost static surface targets, observers are customarily called in to observe the targets and to locate and estimate shooting errors. In virtue of the instructions of the observer, the gunners then make corrections by aiming the barrel of the weapon anew. This procedure of correction is time-consuming and hazardous for the observer and is unsuitable in such cases in which fast moving surface or air targets are to be fought against.

### SUMMARY OF THE INVENTION

Accordingly, it is an object of the present invention

to suggest a method of the type mentioned herein above that may also be successfully carried out in fighting fast moving surface and air targets, and

to devise a field suitable device for carrying said method into effect, particularly in such a manner that it operates irrespective of external influences and does not necessitate any substantial adjusting or calibrating procedure.

According to the invention, the solution to this object is characterized

It is advisable to make use of a measuring facility with a gyroscopic measuring element; a correction device is thus obtained which operates irrespective of external influences and does not require any substantial regulating operations.

The measuring facility of preference for the device according to the invention, which is very suited to said device, contains a gyroscopic measuring element designed as a fiber optical gyro, the design and way of operation of which will be described herein after. Fiber optical gyros are characterized by their robustness, they are almost maintenance-free as they do not soil; as contrasted with mechanical gyroscopes, they hardly wear as they have no moving component parts and, unlike laser gyros, they are relatively inexpensive.

Generally, fiber optical gyros have a certain gyro drift; this means that the angle they show also changes when the angle that is to be measured, termed error angle in our case, is zero. Therefore, the measurement process does not start with the measurement of the error angle but with the previously to be determined ascertainment of the gyro drift or of the drift velocity of the fiber optical gyro utilized. The gyro drift is measured several times at intervals of time to determine the drift velocity and the drift velocity is then calculated from the thereby obtained measuring results.

In a first variant of the measurement process of the method according to the invention, a first gyroscopic angle is measured directly before shooting and a second gyroscopic angle, directly after the shot has been fired. The difference between the first and the second gyroscopic angle, minus the drift angle extrapolated from the gyro drift, equals the error angle by which the lower carriage has been displaced relative to its base area in consequence of a first shot. The measuring signal corresponding to this error angle is utilized to correct the direction of the barrel of the weapon for the following shot.

In a second variant of the measurement process of the method according to the invention, the gyroscopic angle is measured continuously while firing the shot. The gyroscopic angle minus the drift angle yields the error angle by which the lower carriage has been displaced relative to its base area as a result of continuous shooting. The measuring signal corresponding to this error angle is utilized to correct the direction of the barrel of the weapon for continuous shooting.

Since the drift angle changes steadily or since the drift velocity does not change suddenly, the drift angle needs not be permanently determined, it is sufficient to determine it at intervals of time, e.g., once in an hour.

Hitherto, the only corrections considered have been those by means of which such shooting errors are avoided which occur as a result of the rotation of the lower carriage on its base area about the vertical axis. These shooting errors however only constitute a share of all the shooting errors that occur on account of the change of position of the lower carriage which is occasioned by the recoil forces. In addition to its rotation about the vertical axis, the lower carriage can also rotate about the transverse axis and about the longitudinal axis. The herein above described rotation about the vertical axis, which corresponds to a rotation relative to the base area, causes above all—but not necessarily exclusively—the azimuth to change. Rotation about the transverse axis, which corresponds to a nodding movement, causes above all—but not necessarily exclusively—the elevation to change. Rotation about the longitudinal axis, which corresponds to a lateral tilting motion, causes both the azimuth and the elevation to change.

In the simplest embodiment of the invention there is provided to only compensate, by changing the azimuth, that displacement of the barrel of the weapon which is occasioned by the rotation of the lower carriage about the longitudinal axis. This is particularly sufficient when at least almost even base areas or homogeneous base areas are available and when the bottom surface is uniform so that hardly any nodding or tilting motions occur because the lower carriage does not sink in, thereby resting locally in a way that differs from that in which it lies on the original base area. The measuring facility hereby merely contains one measuring element and the control facility but one control unit.

In an improved embodiment of the invention, the displacement of the barrel of the weapon which is caused by the nodding movement of the lower carriage and the displacement of the barrel of the weapon which is caused by the tilting movement of the lower carriage are additionally compensated. Although it would be possible to compensate the displacement occasioned by the nodding motion only, or only the displacement occasioned by the tilting motion, the cost-benefit ratio thereof would be relatively disadvantageous since nodding and tilting movements, which occur above all on soft bottom surfaces, mostly occur together.

### BRIEF DESCRIPTION OF THE DRAWINGS

The invention will become apparent from the following detailed description of exemplary embodiments with reference to the drawing.

FIG. 1 shows a gun with a gyro measuring element in a graphical representation;

FIG. 2 shows a gyro measuring element designed as a fiber optical gyro in schematic representation;

FIG. 3 shows a diagram intended to explain the interrelationship between drift angle, gyroscopic angle and error angle in function of the time; and

FIG. 4A and FIG. 4B show two flow charts intended to explain the data flow in the method according to the invention.

### DESCRIPTION OF THE PREFERRED EMBODIMENTS

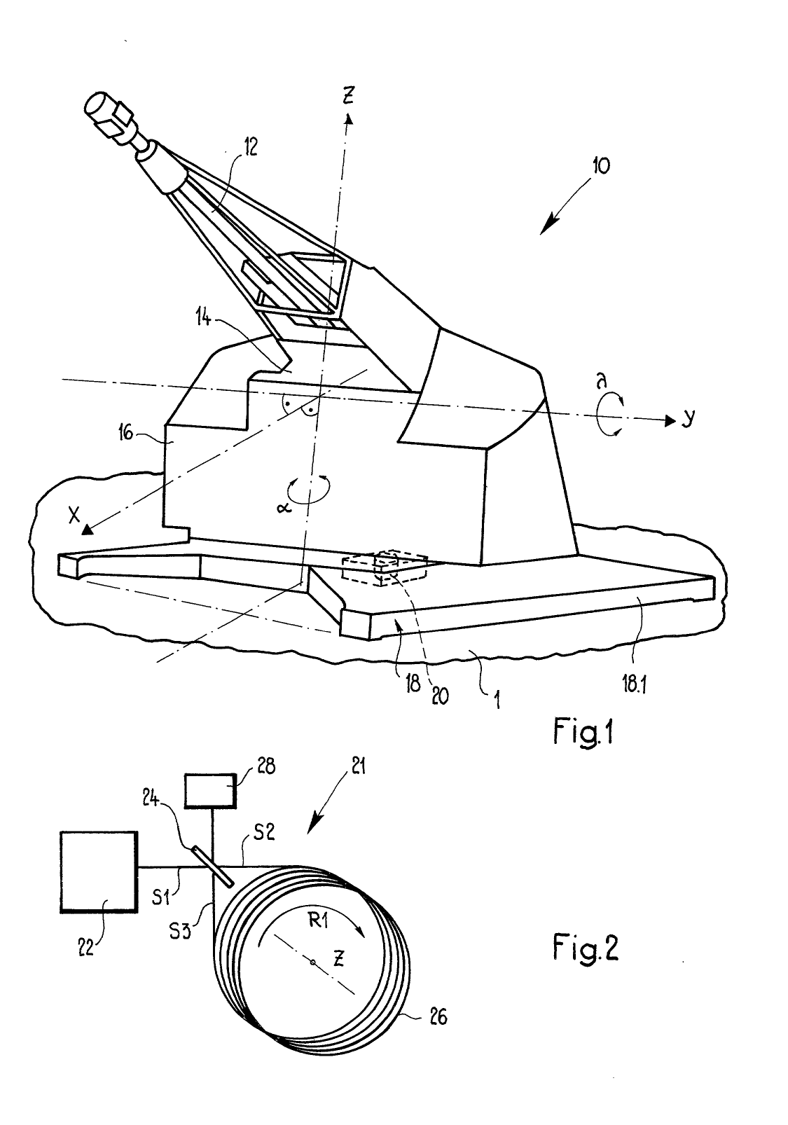

FIG. 1 shows a gun 10 that essentially consists of a weapon with a barrel of a weapon 12, a cradle 14, an upper carriage 16 and a lower carriage 18; cradle 14, upper carriage 16 and lower carriage 18 together form a weapon mounting. The lower carriage 18 is stationary or is considered to be stationary; deviations of the lower carriage from its nominal position in consequence of shots are taken into account by the novel method. To adjust the azimuth α, the upper carriage 16 can be pivoted about the vertical axis Z relative to the lower carriage 18. To adjust the elevation λ, the cradle 14 in which the weapon is fastened can be pivoted about the transverse axis Y relative to the upper carriage 16. The longitudinal axis X is oriented normal to the plane YZ defined by the vertical axis Z and the transverse axis Y. Even in a fully symmetrical gun, the plane XZ defined by the vertical axis Z and the longitudinal axis X only coincides with the longitudinal center plane or with the plane of symmetry of the gun 10 when the barrel of the weapon 12 adopts its central position according to FIG. 1.

A measuring unit 20 of a non illustrated measuring facility including a gyro measuring element in the form of a fiber optical gyroscope is accommodated on the central portion 18.1 of the lower carriage 18. The measuring element is designed and accommodated in such a manner that it detects angle changes or error angles Δζ respectively according to the rotation of the lower carriage 18 relative to the base area 1.

In addition to the gyro measuring element 20 fastened on the support 18.1, the measuring device can also be provided with one or several additional gyro measuring elements or with measuring elements of another design which are also intended to determine the error angle Δζ. The additional measuring elements can be utilized to obtain a safe value for the error angle Δζ by defining the mean, or they can be used as redundant gyro measuring elements.

The gyro measuring element 20 and possibly the additional measuring elements may be fastened at arbitrary locations on the lower carriage 18. It should be seen to it though that the measuring elements be accommodated in such a way that they are protected against damages.

The gyro measuring element 20 is provided with a fiber optical gyroscope 21 which is shown in schematic form in FIG. 2. The fiber optical gyroscope 21 essentially consists of a light source in the form of a laser 22, of a beam splitter 24, a fiber coil 26 and a detector 28. At the beam splitter 24, a beam S1 emitted by the laser 22 is divided into two partial beams S2, S3 which subsequently traverse the fiber coil 26 in opposite direction. By rotating the fiber optical gyroscope 21 about an axis Z oriented normal to the plane of the fiber coil 26, the Sagnac effect comes into effect, that is, the partial beam S2 running in direction R1 of the rotation of the fiber coil 26 needs more time to traverse the fiber coil 26 than the partial beam S3 revolving in the opposite direction. Once they have traversed the fiber coil 26, the partial beams S2, S3 interfere, the interference pattern generated depending on the rotating speed. This change in the interference pattern is detected by detector 28. The change in the interference pattern, which corresponds to the rotating speed, permits in the end to determine by integration by way of time the angle of rotation which, in the present case, is the error angle Δζ. In another embodiment of the fiber optical gyroscope, the angle of rotation is determined from the Doppler effect which results from the partial beams revolving in opposite directions in the fiber coil.

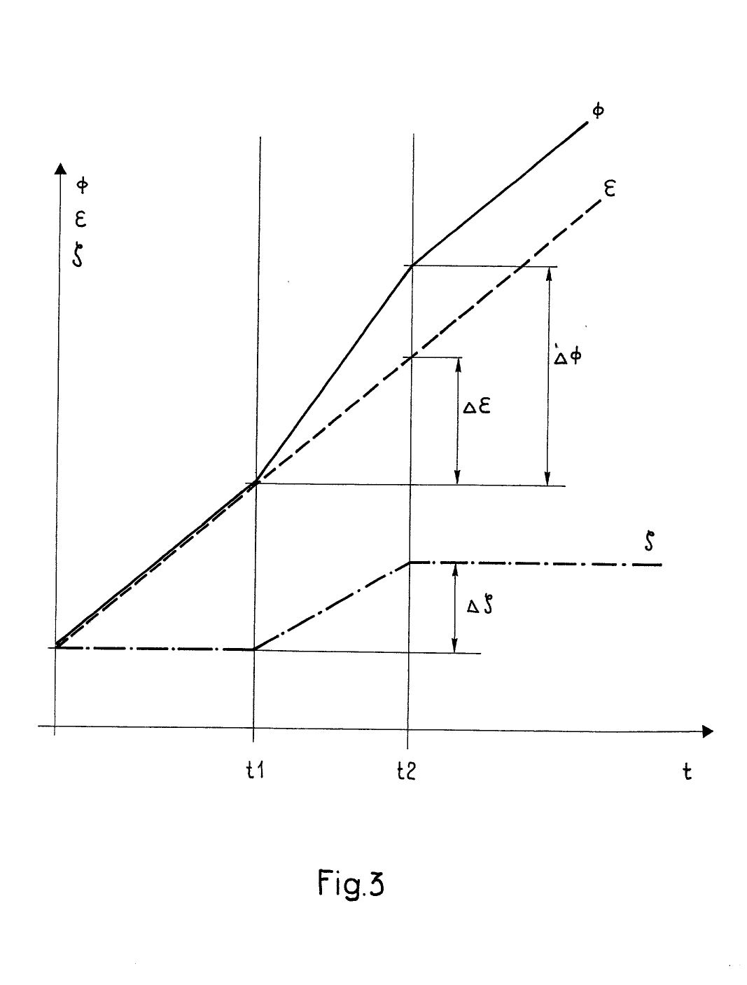

The way of operation of the gyro measuring element 20 which includes the fiber optical gyroscope 21 will be described herein after with reference to FIG. 3. In FIG. 3, angles are laid off as abscissa and the time t as ordinates. A shot is fired in the time period between t1 and t2. The full line corresponds to the gyroscopic angle φ which is determined by the fiber optical gyroscope 21; the broken line corresponds to the drift angle ε; the dot-dash line corresponds to the angle termed the error angle ζ of the rotation of the lower carriage 20 about the vertical axis Z. Prior to the time t1, the gyroscopic angle φ equals the drift angle ε.

In the period of time between t1 and t2 in the course of which the shot is fired, the drift angle increases by Δε at the same pitch as before t1; in consequence of the shot, the gyroscopic angle φ increases by Δφ. In the time after t2, that is, after the shot has been fired, the drift angle ε still increases at the same pitch; here again, its increase corresponds to the increase of the gyroscopic angle φ. In order to determine the error angle Δζ occasioned by the shot, the gyroscopic angle φ(t1) is determined at the beginning of the shot and the gyroscopic angle φ(t2) at the end of the shot, the increase of the gyroscopic angle Δφ=φ(t2)−φ(t1) being determined therefrom. The increase of the drift angle during the shot is determined therefrom; as a matter of fact, it amounts to Δε=ε(t2)−ε(t1). The error angle Δζ, which is also termed slip angle, equals the increase of the gyroscopic angle Δφ minus the increase of the drift angle Δε, i.e., Δζ=Δφ−Δε. Some single steps that have just been described to determine the error or slip angle may be interchanged.

In order to obtain the correct value for the error angle Δζ, the gyroscopic angle is possibly to be equalized with the coder angle of the gun 10 as an additional step prior to carrying out the measuring process.

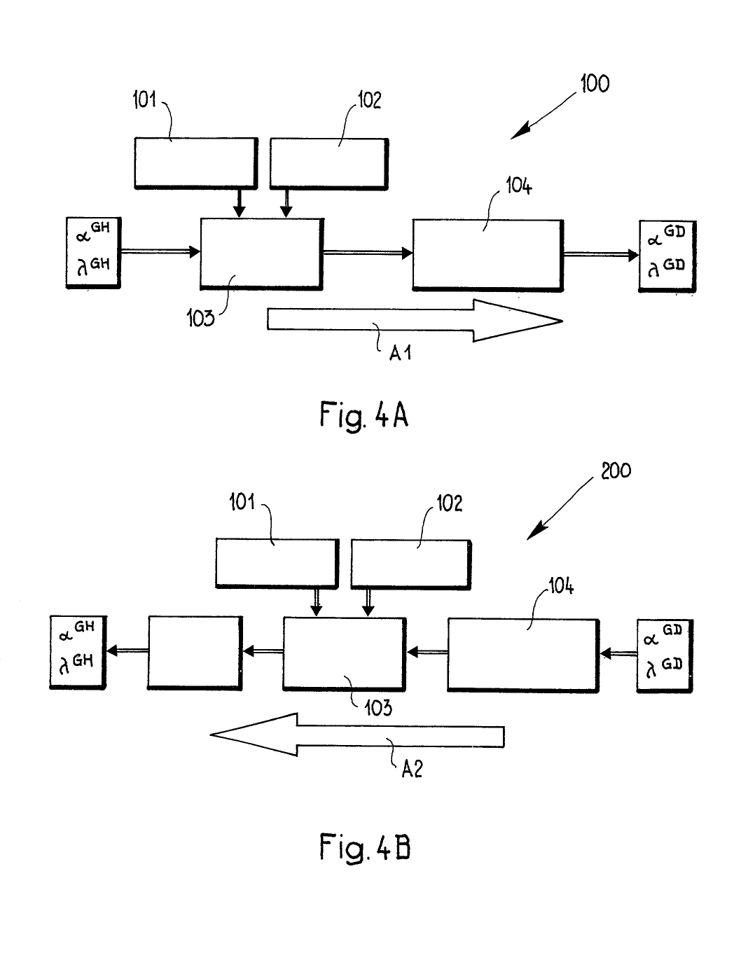

FIG. 4A and FIG. 4B show simplified schemata 100 and 200 to explain the data flow when carrying out the method according to the invention, wherein the direction of the nominal data is indicated by the arrow A1 in FIG. 4A and the direction of the actual data by the arrow A2 in FIG. 4B. The tilting angle is indicated at 101, the gyroscopic angle at 102, the data of the fire control for the azimuth at α^{GH} and for the elevation at λ^{GH}, the transformation into the deck system S^{GD} at 203, the correction of the gun's parameters at 204 and the data of the servo units for the azimuth at α^{GD} and for the elevation at λ^{GD}.

As already mentioned, in the simplest embodiment of the device according to the invention, the control facility is provided with but one control unit by means of which the azimuth α is corrected. In this process, if the gun stands on an inclined plane, it is tolerated that the error of the elevation is not corrected.

In order to improve correction, the control device can be provided with an additional control unit by means of which the elevation is corrected.

The control facility is provided with a computer which either consists in a gun computer or in a fire control computer.

Hitherto, merely the correction of the direction of the barrel of the weapon, which is made to compensate the rotation of the lower carriage about the vertical axis Z, has been described. In order to take into consideration, for the correction of the direction of the barrel of the weapon 12, not only the rotation about the vertical axis Z but also the rotation about the transverse axis Y or the nodding motion respectively, the measuring device must be provided with an additional measuring element for determining the error angle Δψ which corresponds to the rotation about the Y-axis. This measuring element too is preferably devised as a gyro measuring element, more particularly as a fiber optical gyroscope, and the determination of Δψ is conducted in the same way as the determination of Δζ. Several measuring elements may also be provided for to determine the error angle Δζ. Hereby, the control facility always includes a control element for correcting the azimuth and a control element for correcting the elevation.

In order finally to take into consideration, for the correction of the direction of the barrel of the weapon 12, not only the rotation about the vertical axis Z and the rotation about the transverse axis Y but also the rotation about the longitudinal axis X or the tilting motion respectively, the measuring device must be provided with an additional measuring element for determining the error angle Δξ which corresponds to the rotation about the longitudinal axis. This measuring element too is preferably devised as a gyro measuring element, more particularly as a fiber optical gyroscope, and the determination of Δξ is conducted in the same way as the determination of Δζ and Δψ. Here as well, several measuring elements may be provided for to determine the error angle Δξ. Again, the control facility always includes a control element for correcting the azimuth and a control element for correcting the elevation.

1. Method of correcting shooting errors that are occasioned by a movement of a barrel (12) of a gun (10) leaving its nominal position in consequence of a movement of a lower carriage (18) on firing a shot, wherein
with the help of an angle meter element, an error angle (Δζ) is determined along which the lower carriage rotates about the vertical axis (Z),
an error signal is obtained from the error angle and
the error signal is utilized to change the azimuth (α) of the barrel (12) in order to compensate an error of the azimuth (α) and of the elevation (λ) occasioned by a rotation of the lower carriage (18) about the vertical axis (Z).

2. Method according to claim 1, wherein
with the help of an additional angle meter element, an error angle (Δψ) is determined along which the lower carriage (18) rotates about the transverse axis (Y),
an additional error signal is obtained from the error angle of the additional angle meter element and
the additional error signal is utilized to change the azimuth (α) and the elevation (λ) of the barrel of the weapon (12) in order to compensate the error of the azimuth and of the elevation occasioned by the rotation of the lower carriage (18) about the transverse axis (Y).

3. Method according to claim 1, wherein
with the help of an additional angle meter element, an error angle (Δξ) is determined along which the lower carriage (18) rotates about the longitudinalaxis (X),
an additional error signal is obtained from the error angle of the additional angle meter element, and
the additional error signal is utilized to change the azimuth (α) and the elevation (λ) of the barrel of the weapon (12) in order to compensate the error of the azimuth and of the elevation occasioned by the rotation of the lower carriage (18) about the longitudinal axis (X).

4. Method according to claim 1, wherein
a gyro measuring element is utilized as the angle meter element to determine the error angle (Δζ,Δψ,Δξ).

5. Method according to claim 4, wherein
the gyro measuring element used is a fiber optical gyroscope and
the time history of a drift angle (ε) of the fiber optical gyroscope is determined prior to firing the shot.

6. Method according to claim 5, wherein
a first gyroscopic angle (φ(t1)) of the fiber optical gyroscope of the fiber optical gyroscope is determined at the start of the shot,
a second gyroscopic angle (φ(t2)) is determined at the end of the shot,
a difference of the gyroscopic angles (⊕3) between the first gyroscopic angle (φ(t1)) and the second gyroscopic angle (φ)(t2)) is determined,
a difference of the drift angles (Δφ) while the shot is being fired is determined, and
the error angle (Δζ,Δψ,Δξ) is determined by subtracting the difference of the drift angles (Δε) from the difference of the gyroscopic angles (Δφ), and
the error signal which is obtained from the error angle (Δζ,Δψ,Δξ) and which is used to change the azimuth (α) and possibly the elevation (λ) is utilized for the subsequent shot.

7. Method according to claim 5, wherein
the time history of the gyroscopic angle (φ) of the fiber optical gyroscope is determined while firing the shot,
the error angle (Δζ,Δψ,Δξ) is determined by subtracting the drift angle (ε) from the gyroscopic angle (φ), and
the error signal which is obtained from the error angle (Δζ,Δψ,Δξ) is utilized to change the azimuth (α) while firing the shot.

8. Method according to claim 1, wherein,
prior to determining the error angle (Δζ,Δψ,Δξ), the angle meter element is equalized with coder angles of the gun (10).

9. Device for correcting shooting errors that are occasioned by a motion of a barrel (12) of a gun (10) leaving its nominal position in consequence of a motion of a lower carriage (18) when firing a shot, wherein the gun (10) is provided with a drive having a drive unit for adjusting the azimuth (α) and a drive unit for adjusting the elevation (λ) of the barrel of the weapon, wherein
a measuring facility (20) is fastened on the lower carriage (18), said measuring facility being provided with a measuring element designed to determine an error angle (Δζ) by which the lower carriage (18) rotates about the vertical axis (Z) when firing the shot,
an output of the measuring facility is connected to an input of a control facility which is designed to determine a correction for the azimuth (α) from the error angle (Δζ), and
an output of the control facility is connected to the drive unit provided for setting the azimuth (α) in order to compensate the change of the azimuth (α) and of the elevation (λ) of the barrel of the weapon (12) occasioned by the motion of the lower carriage.

10. Device according to claim 9, wherein
the control facility is devised to determine a correction for the elevation (λ) from the error angle (Δζ), and
an additional output of the control facility is connected to the drive unit provided for to set the elevation (λ) in order to compensate the change of the elevation (λ) of the barrel of the weapon (12) occasioned by the motion of the lower carriage.

11. Device according to claim 10, wherein
the measuring facility is provided with an additional measuring element which is fastened on the lower carriage and is designed to determine the error angle (Δψ) by which the lower carriage (18) rotates about the transverse axis (Y) when the shot is being fired,
an output of the measuring facility is connected to an input of the control facility which is designed to determine a correction for the azimuth (α) and the elevation (λ) from the error angle (Δψ).

12. Device according to claim 9, wherein
the measuring facility is provided with an additional measuring element which is fastened on the lower carriage and is designed to determine the error angle (Δξ) by which the lower carriage (18) rotates about the longitudinal axis (X) when the shot is being fired,
an output of the measuring facility is connected to an input of the control facility which is designed to determine a correction for the azimuth (α) and the elevation (λ) from the error angle (Δξ).

13. Device according claim 10, wherein
the measuring element of the measuring facility is a gyro measuring element.

14. Device according to claim 13, wherein
the gyro measuring element is provided with a fiber optical gyroscope, and
the measuring facility is provided with a device for determining the time history of the drift angle (ε) of the fiber optical gyroscope and of the difference of the drift angle (Δε) while firing the shot.

15. Device according to claim 14, wherein
the measuring facility is provided with
a facility to determine
a first gyroscopic angle (φ(t1)) at the start of the shot,
a second gyroscopic angle (φ(t2)) at the end of the shot and
a difference of the gyroscopic angles (⊕4) as the difference between the first gyroscopic angle (φ(t1)) and the second gyroscopic angle (φ(t2)) and
a facility to determine the error angle (Δζ,Δψ,Δξ) by subtracting the difference of the drift angle (Δε) from the difference of the gyroscopic angle (Δφ),
the drive units being devised and arranged in such a manner that they are activated at the end of the shot.

16. Device according to claim 15, wherein
the measuring facility is provided with
a facility to determine the time history of the gyroscopic angle while firing the shot,
a facility to determine the time history of the error angle (Δζ,Δψ,Δξ) by subtracting the drift angle (ε) from the gyroscopic angle (φ),
the drive units being devised and arranged in such a manner that they are activated while firing the shot.

17. Device according to claim 9, wherein
the measuring facility is provided with an equalization device in order to equalize the measuring elements with the coder angles of the gun prior to firing the shot.

18. Method according to claim 5, wherein
the time history of the gyroscopic angle (φ) of the fiber optical gyroscope is determined while firing the shot,
the error angle (Δζ,Δψ,Δξ) is determined by subtracting the drift angle (ε) from the gyroscopic angle (φ), and
the error signal which is obtained from the error angle (Δζ,Δψ,Δξ) is utilized to change the azimuth (α) and possibly the elevation (λ) while firing the shot.
